(19) United States
(12) Patent Application Publication
(10) Pub. No.: US 2021/0041929 A1
(43) Pub. Date: Feb. 11, 2021

(54) DYNAMIC NETWORK CONTROLLER POWER MANAGEMENT

(71) Applicant: Intel Corporation, Santa Clara, CA (US)

(72) Inventors: Patrick Lewis Connor, Beaverton, OR (US); James R. Hearn, Portland, OR (US); Kevin D. Liedtke, Portland, OR (US); Scott P. Dubal, Oregon City, OR (US); Benjamin Cheong, Tigard, OR (US); Rafael Guerra, Hillsboro, OR (US)

(73) Assignee: Intel Corporation, Santa Clara, CA (US)

(21) Appl. No.: 17/076,776

(22) Filed: Oct. 21, 2020

(51) Int. Cl. G06F 1/26; G06F 13/20

(52) U.S. Cl. CPC G06F 1/26; G06F 2213/24; G06F 13/20

(57) ABSTRACT

An I/O controller includes a port to couple to a network, a buffer to buffer network data, and an interface to support a link to couple the I/O controller to another device. The I/O controller monitors a buffer to determine an amount of traffic on the port, initiates, at the interface, a power management transition on the link based on the amount of traffic, and mitigate latency associated with the power management transition at the port.

### FIELD

The present disclosure relates in general to the field of computer development, and more specifically, to power management of peripheral devices.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2 is a simplified block diagram illustrating an example processor architecture.

FIG. 3 is a simplified block diagram illustrating an example I/O controller device.

FIGS. 4A-4B are simplified block diagrams illustrating transitions between different link widths of a link.

FIG. 5 is a diagram illustrating an example state machine for a link.

FIG. 6 is a diagram illustrating an example configuration substate machine.

FIG. 7 is a flow diagram illustrating example techniques for managing power consumption at an I/O controller.

FIG. 8 illustrates a block diagram of an example processor device in accordance with certain embodiments.

Like reference numbers and designations in the various drawings indicate like elements.

### DETAILED DESCRIPTION

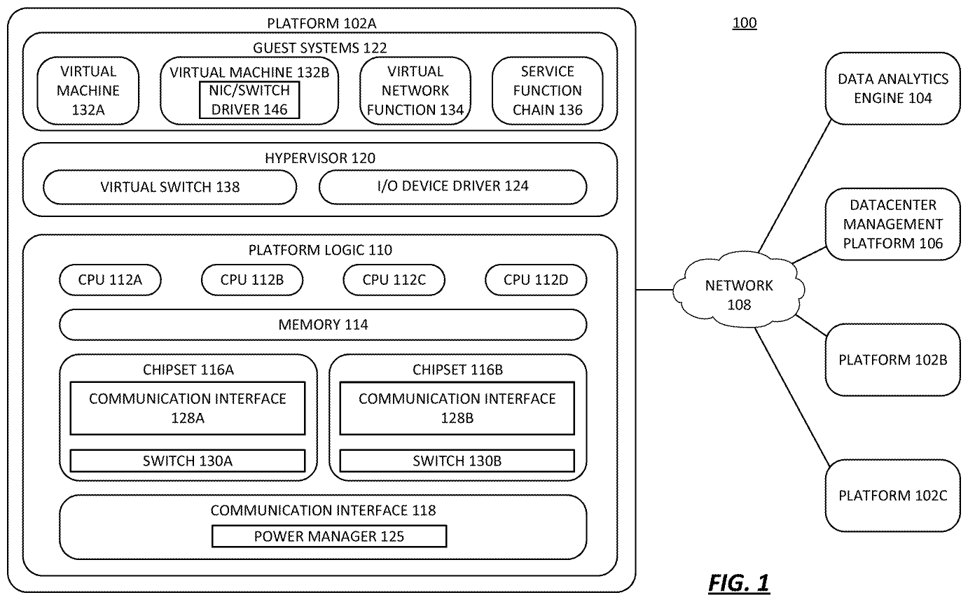

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

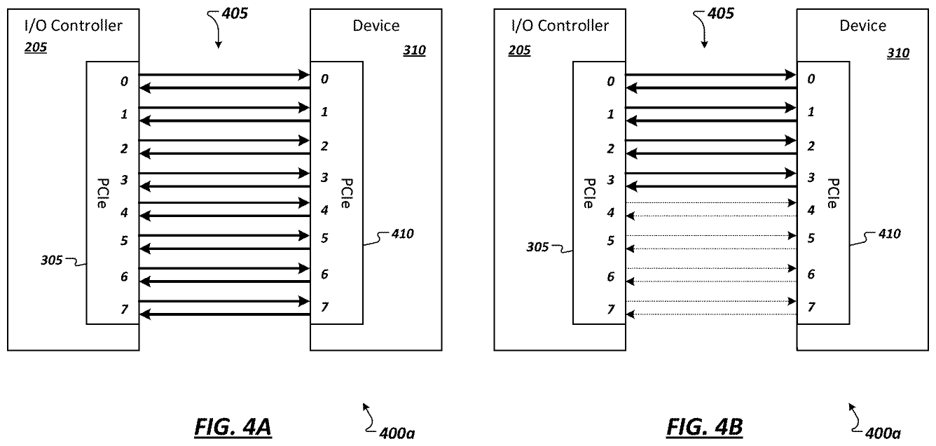

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. CPU 112 is described in further detail below in connection with FIG. 4. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (i.e., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (i.e., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g. firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (i.e., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

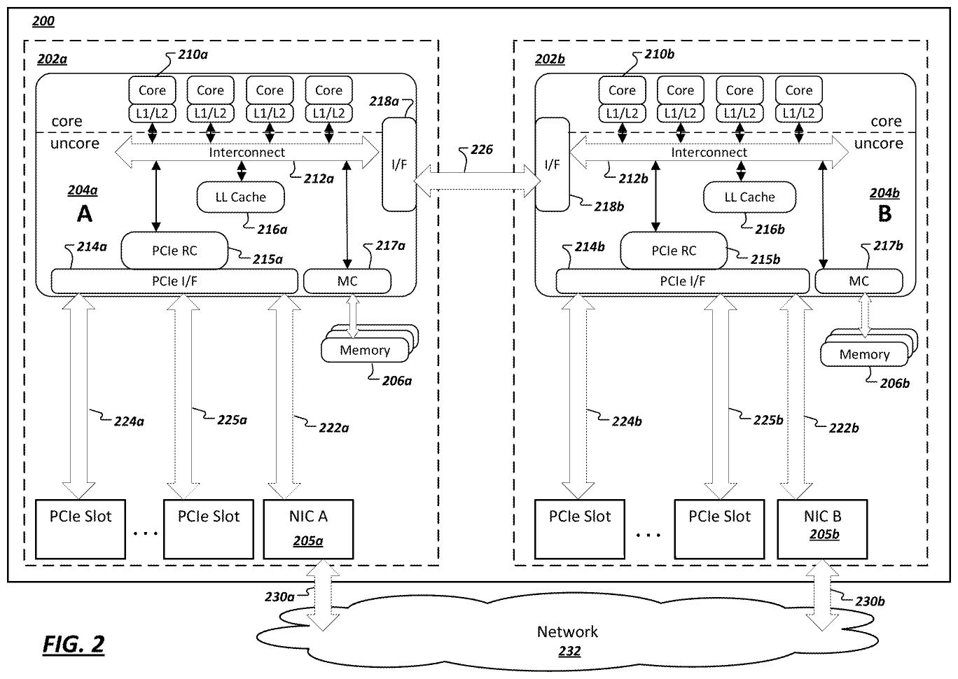

FIG. 2 is a simplified block diagram illustrating an example Non-Uniform Memory Access (NUMA) multi-processor platform architecture 200 employing two NUMA nodes 202a and 202b (nodes “A” and “B”). Each node 202a,b may include a respective processor (e.g., processors 204a and 204). Each node may additionally include respective memory (e.g., 206a,b), which may implement portions of system memory, a respective network interface card (e.g., 208a,b), and a number of PCIe slots, in which respective PCIe cards (not shown) may be installed. In some implementations, each processor 204a,b includes a core portion including a plurality of processor cores 210a,b, each including a local level 1 (L1) and level 2 (L2) cache. The remaining portion of the processor may be referred to as the uncore and includes various interconnect circuitry and interfaces for communicatively coupling various functional blocks on the processor. Such interconnect circuitry may implement layers of a layered protocol and implement a corresponding interconnect (e.g., 212a,b), such as a bus, single or multi-lane serial point-to-point connection, mesh interconnect, among other example implementations.

A portion of the uncore circuitry may be configured to manage memory control and PCIe interfaces for devices such as NICs. Corresponding exemplary logic blocks depicted in the processor uncores in FIG. 2 include a PCIe interface (I/F) 214a,b, a PCIe Root Complex (RC) 215a,b, a last level cache (LL Cache) 216a,b, a memory controller (MC) 217a,b, and a socket-to-socket link interface (S-to-S I/F) 218a,b. In addition to these illustrated blocks, each processor 204a,b may include many other functional blocks (e.g., not explicitly illustrated).

Each of processors 204a,b may be operatively coupled to a printed circuit board (e.g., 220) via a socket, or otherwise coupled to the main board via a direct coupling technique, such as flip-chip bonding (referred to collectively as “sockets” herein). Accordingly, the board 220 may include electrical conductors (e.g., traces and vias) to facilitate electrical connections corresponding to the physical structure of various interconnects depicted in FIG. 2. These interconnects include PCIe interconnects 222a,b between PCIe interfaces 214a,b and NICs 205a,b, interconnects 224a,b and 225a,b between PCIe interfaces 214a,b and PCI slots 1-N, and a socket-to-socket link 226 coupled between socket-to-socket interfaces 218a and 218b. In one embodiment, socket-to-socket interfaces 218a and 218b may employ an intraprocessor interconnect protocol and wring structure, such as based on UltraPath Interconnection (UPI), Quickpath Interconnect (QPI), Infinity Fabric, among other examples.

NICs (e.g., 205a,b) are configured to provide an interface with a computer network (e.g., 232) using a corresponding network protocol, such as the Ethernet protocol. A MC may be associated with an operating system (OS) NIC (device) driver that is logically located in an OS kernel. The NIC driver is used as an abstracted interface between the operating system software and the NIC, which is a hardware device. For example, a NIC driver may provide access to registers on a NIC, provide a program interface to the NIC, etc. A NIC driver may also facilitate handling and forwarding of data received via packets from the network to consumers of that data, such as a software application. For instance, packets may be received at a NIC input port and buffered in an input buffer and then copied to a memory buffer in system memory that is allocated to the NIC driver by the operating system.

Under a NUMA architecture, processors (and processor cores) are enabled to access different memory resources distributed across the platform. The memory resources may be considered local memory resources (e.g., memory resources on the same node as a processor or core) or non-local memory resources (e.g., memory resources on other nodes). For example, under the viewpoint of node 202a, system memory 206a comprises a local memory resource, while system memory 206b comprises a non-local memory resource. Under another type of NUMA architecture (not depicted herein), non-local memory resources may also be shared between processors while not being associated with a particular processor or node, among other example features.

Network interface cards (NICs), network adapters, or other network controllers are not always being used at 100% capacity and opportunities exist to optimize their operation. For instance, there are times when transmit and receive traffic are relatively sparse and do not require or utilize the full PCIe bandwidth of the device to service the network. For a network controller (or other input/output (I/O) device), the PCIe interface may be provided with the bandwidth capacity to match the worst-case network I/O, even if this means that much of the time the PCIe bandwidth is not fully utilized.

While some network controllers implement power consumption management techniques, such conventional approaches are suboptimal, both from a power usage and data throughput perspective. Examples of such conventional power consumption management techniques may include Active State Power Management (ASPM) and Direct Memory Access (DMA) coalescing. In such conventional implementations, power reduction achieved through these techniques results in no traffic being handled while in the power consumption management, or low power, state. Further, in the case of APSM, power management is based on monitoring of activity on the PCIe bus, which leads to reactive power state transitions (e.g., rather than predictive or preemptive transitions). Additionally, DMA coalescing is further deficient in that it is not supported by all computing devices and can increase packet processing latency, while delivering relatively small overall power savings, among other example deficiencies.

In some improved systems, power consumption management features may be integrated in or otherwise implemented in I/O controller devices to intelligently and dynamically adjust the width of a corresponding PCIe link based on the amount of network traffic detected at the device. For instance, such I/O controllers may monitor traffic levels on the network (e.g., going through the NIC) and intelligently adjusts the number of PCIe lanes (and/or their data rate) to reduce power when possible without sacrificing network performance. Unlike conventional approaches, such improved implementations may adjust the PCIe link width based on the controllers onboard FIFO state thereby allowing preemptive (rather than reactive) transitions. Additionally, such implementations may utilize buffering on the network switch to mitigate packet loss (or exit latency) during transitions. Indeed, in some implementations, exit latencies may be mitigated either via multi-PCIe-homed controllers or via pause frames, among other example solutions. When pause frames are used, transition types may be configured such that PCIe transitions can occur primarily within the maximum pause time of one pause frame to moderate packet loss during the transition, among other example implementations. Such improved power consumption management functionality may realize significant power savings and reduce both the overall power and thermal load on the system (as well as battery life in mobile computing systems). Further, such improved implementations do not require special support from the network like Energy Efficient Ethernet and may be even be used in addition to or in combination with other power management features such as Advanced Power Management (APM) or ASPM, among other example uses and advantages.

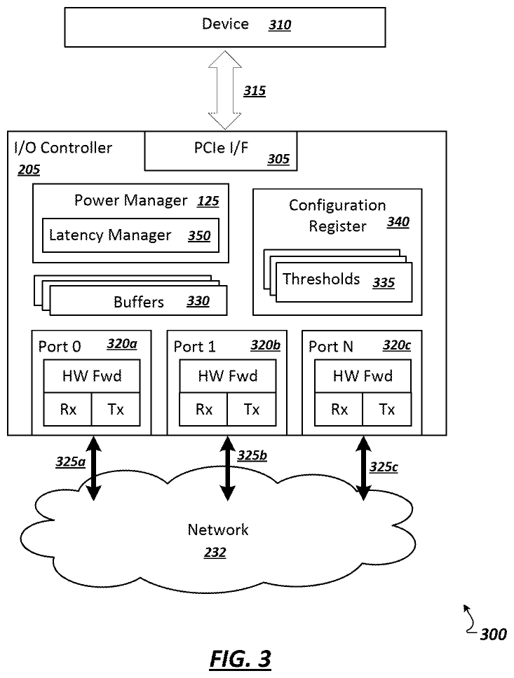

FIG. 3 is a simplified block diagram 300 illustrating an example implementation of an improved I/O controller 205, such as a NIC or network adapter. The I/O controller 205 may couple to another device 310 (e.g., a host processor, board, memory device, accelerator, etc.) via a link (e.g., a PCIe-based link) supported by an interface, such as a PCIe-based interface 305. The I/O controller 205 may couple to one or more networks 232 utilizing one or more ports (e.g., 320a-c). The ports 230a-c may be utilized to establish and communicate over respective links (e.g., 325a-c) according to one or more protocols (e.g., Ethernet-based protocols). In some implementations, a power manager 125 (e.g., implemented in hardware or firmware of the I/O controller 205) may be provided to proactively and predictably implement power consumption management at the interface 305 of the I/O controller, such as introduced above. Network traffic (sent and received) at ports 320a-c may be detected and monitored (e.g., using power manager 125) by monitoring buffers (e.g., FIFOs) 330 of the I/O controller 205. In some implementations, power management tasks (such as discussed herein) may be triggered based on the realization of defined thresholds (e.g., as defined in threshold data 335 stored in configuration registers (e.g., 340) hosted or associated with the I/O controller), among other example features.

As discussed herein, improved systems, such as shown in the example of FIG. 3, may be equipped with power manager logic 125 to permit an I/O controller to monitor ingress and egress traffic (and the state of its FIFO buffers (e.g., 330) in local memory) and automatically enable or disable PCIe lanes and/or adjusts the data rate of the PCIe lanes (of link 315) adaptively (using interface logic 305) to accommodate the identified I/O traffic or changes in I/O traffic (e.g., from or to the network). Such enhanced functionality helps reduce power consumption and reduce the heat emissions from the PCIe controllers and I/O peripherals, among other example advantages. While some of the examples discussed herein may apply such features to an Ethernet-based I/O controller, it should be appreciated that the more generalized principles disclosed herein may be equally applied to other non-Ethernet-based I/O controllers (e.g., controllers utilizing other network I/O protocols). In some instances, these enhanced features may be provided in addition to other more conventional power consumption management features, such as ASPM, Energy Efficient Ethernet (EEE), Green Ethernet, etc. For instance, dynamic changes to PCIe link widths and data rates may be implemented in concert with other, additional power management techniques to save power while the device is in an “on” or active transmitting state (e.g., DO) at times when processing packets is needed but full throughput is not required. In some implementations, when the I/O controller detects no traffic or another idle condition, the I/O controller may make use of conventional power management techniques, such as ASPM/EEE, to put the device to sleep/wake, among other example implementations.

In some implementations, the sensitivities and conditions for adjusting PCIe lane and speeds based on network activity may be configurable (e.g., set by a user, such as a server administrator, vendor, end user, etc.). For instance, threshold values may be set (e.g., in threshold data 335) for combinations of PCIe link width and speed settings, such that when traffic hits or falls below a threshold, a corresponding dynamic change in link width and/or data rate may be automatically initiated. For instance, user-configurable Dynamically Adjustable PCIe Lane and Speed (DAPLS) threshold and time values may be set (e.g., in a register) in the I/O controller (e.g., at driver initialization time). DAPLS thresholds that are based on amount of traffic detected at the controller may be additionally associated with time values that dictate an amount of time at which the traffic amount is maintained before a corresponding action (e.g., link width change or data rate change) is triggered. The I/O controller 205 can utilize these thresholds to determine when to adjust the PCIe lane width/speed configuration. Depending on the use case, a variety of different DAPLS threshold values may be configured, for instance, to favor power savings, to favor throughput, or attempt to optimize a balance between power savings and throughput, among other examples.

In some implementations, improved power consumption management features may be selectively enabled during operation (or at boot time). For instance, one or more power savings modes may be defined in which an improved power consumption management mode or other power management features are enabled. In some implementations, a power savings mode may be enabled when the user has enabled this feature and both ingress and egress network traffic have been below a DAPLS low/enable threshold for a configurable amount of time (e.g., 30 seconds). Note that in addition to the delay, the enable power savings thresholds may be lower than the increase bandwidth thresholds to prevent rapid toggling between these two states, among other example implementations.

In the case of ingress traffic (with a power savings mode enabled), the network adapter or other I/O controller may monitor its receive FIFO buffer. Packets received over a network connection link may be initially placed in the receive FIFO of the I/O controller until they are transferred to another device or system element coupled to the I/O controller (e.g., host memory) over a PCIe bus coupling the I/O controller to the other device. If the PCIe bus is not keeping up with the incoming network traffic rate, the FIFO will fill. When the receive FIFO fills beyond one of the DAPLS thresholds, it may be assumed that the PCIe bus is not sufficiently keeping up with the rate of network traffic. Accordingly, based on detecting the meeting of a DAPLS threshold, the I/O controller may initiate an automated adjustment of the data rate of the PCIe bus and/or an increase in the link width of the PCIe bus. In some implementations, to buy time for the transition in data rate or link width, the I/O controller may additionally act to quiesce incoming network traffic, such as by sending a pause frame to the link partner to momentarily halt incoming traffic, among other example implementations.

In the case of egress traffic, when the I/O controller is in power savings mode, it will monitor the depth of a buffer or queue used to store packets that are to be transmitted out onto the network (e.g., to a link partner connected via an Ethernet link). For instance, the I/O controller may monitor a transmit descriptor queue. In such implementations, transmit packets are queued in the transmit descriptor ring before they are transferred across the PCIe bus and sent onto the network. If the number of packets (or number of descriptors) in the descriptor ring meets a particular DAPLS transmit threshold then (similar to when a receive threshold is crossed) the I/O controller automatically adjusts the number of enabled lanes and/or data rate of the lanes (e.g., and sends a pause frame), among other examples.

In one example, a runtime flow may include initialization of the I/O controller including the enabling of improved power management logic (e.g., DAPLS logic). Once enabled, the improved power management logic begins monitoring ingress and egress network traffic (e.g., by monitoring corresponding buffer usage, among other example techniques). In cases of high traffic, traffic thresholds may be identified to cause the I/O controller device to ramp up (e.g., step-wise or gradually) active lanes and/or data rate until its PCIe link is up to full speed/link width and maximum power consumption. In cases of low traffic, traffic thresholds may be identified to cause the I/O controller device to gradually ramp down lane speed and/or link width. If no traffic is detected, a conventional power management mode may be enabled or entered, for instance, by transitioning to D3 Hot using standard ASPM. These techniques may continue (e.g., looping between standard power management modes when no traffic is detected and a DAPLS mode when traffic is active on the network link), among other example implementations.

In some implementations, multiple network traffic (or representative buffer) thresholds may be defined for an I/O controller, upon which the initiation of various power management actions (or transitions (e.g., in data rate or link width)) may be based. Indeed, multiple different power management actions (e.g., transitions between various link widths and/or data speeds) may be associated with each of the multiple thresholds. In some implementations, the threshold values as well as their associated power management transitions may be defined or configured by a user. As detailed below, different power management transitions may introduce different, corresponding latency to perform the transition. In some implementations, a power manager (e.g., 125) may be equipped with latency manager logic (e.g., 350) to initiate latency mitigations to correspond to the triggering of corresponding power management transitions. For instance, a pause frame or other signal may be sent on a network port to temporarily quiesce network traffic for a length of time corresponding to a determined power management transition latency. In other examples, data intended to be received or sent on one port (e.g., 320a) of the I/O controller may be sent on another port (e.g., 320b) or even another NIC of the system while a power management transition is taking place, among other example implementations.

Turning to FIGS. 4A-4B, simplified block diagrams 400a-b are shown illustrating the example adjustment of link width of an example PCIe link 405 (e.g., a PCIe link coupling an I/O controller 205 to another device 310 via interfaces 305, 410). Generally, a connection between two devices (e.g., 205, 310) may be referred to as a link, such as a PCIe-compliant link. A link may support one or more lanes—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs, among other example implementations.

During training of a link, a number of physical lanes may be selected and configured to be included (and used) in the link 405. These lanes may be brought to an active state, while one or more other lanes may be held in an idle or reserved state. FIG. 4A shows an example of a link 405 operating at full link width (e.g., where all or a highest supported number of available lanes are active and used to send and receive data on the link). At full link width, the link is able to operate at highest bandwidth. As shown in FIG. 4B, a subset of lanes (e.g., Lanes 4-7) of the link 405 may be disabled or placed in a low power or idle link state to save power and consequently reduce the bandwidth of the link. As discussed herein, a power manager of an I/O controller may trigger automatic transition of a link from one link width (e.g., a full link width) to another link width (e.g., partial link width) to dynamically manage power based on traffic detected at the I/O controller. Multiple different link widths (e.g., numbers of active lanes (e.g., x1, x2, x4, x8, x16)) may be supported and utilized (e.g., associated with meeting various defined traffic thresholds) by the I/O controller to manage power consumption along with dynamic speed changes, such as discussed herein.

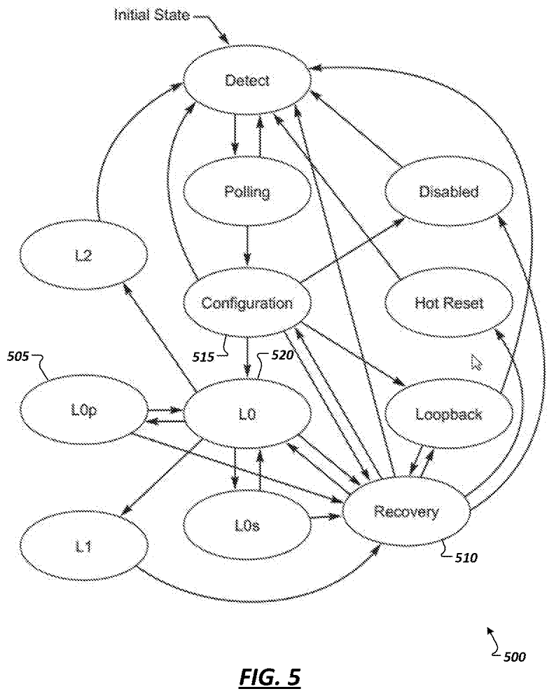

FIG. 5 illustrates an example state machine diagram 500 for a PCIe-based protocol, such as PCIe 6.0. Link states in a link training and status state machine may be provided, which may be utilized to change the link width and/or data rate used by a link. Training sequences (e.g., PCIe TS1 and TS2 training sequences) may be defined with formats (e.g., defined informational fields), which may be communicated in particular states to allow link partner devices (e.g., an I/O controller and a connected device) to coordinate a transition from one data rate to another (e.g., and perform corresponding configuration, equalization, etc.) and/or transitions between link widths. In one example, a partial width link state (e.g., L0p) may be defined in an PCIe-based protocol. For instance, PCIe 6.0 may support a flit mode, in which flit encoding is utilized (e.g., as an alternative to non-return-to-zero (NRZ) encoding). In flit mode, an L0p state 505 is defined with flit encoding (e.g., at data rates of 8.0 GT/s and above). In an L0p state, some lanes are in sleep state (turned off) with at least one lane in an active transmitting state and transferring normal data blocks/flits. For example, in L0p, a x16 link may have only 8 lanes active (e.g., Lanes 0-7) and the other 8 Lanes (e.g., Lanes 8-15) are turned off. From that state, the link may be further reduced to 1 lane active (e.g., Lane 0) and the other 15 lanes (e.g., Lanes 1-15) turned off. All these transitions may happen without hampering normal traffic (e.g., the link does not enter Recovery 510 or Configuration 515). When all of the configured lanes are activated, the LTSSM enters the L0 state 520.

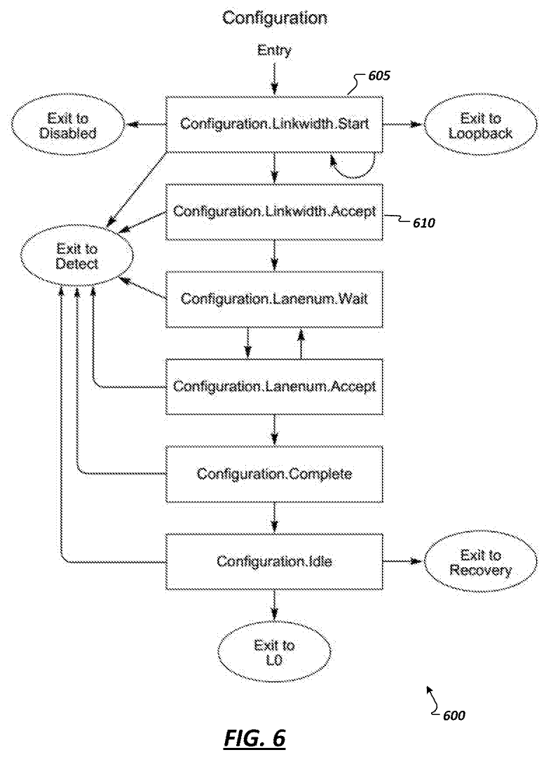

In some implementations (e.g., pre-6.0 PCIe or non-flit mode PCIe 6.0), other states (e.g., Recovery and Configuration 515) may be entered (e.g., from L0 520) to enable a transition from a first link width or data rate to another link width or data rate, among other example implementations. FIG. 6 illustrates an example Configuration substate machine 600. For instance, Configuration substates may include a Configuration.Linkwidth.Start 605 and Configuration.Linkwidth.Accept 610 substate, in which training sequences may be exchanged to negotiate the link width that is to be applied in the link. In some implementations, a link may first enter a Recovery state (e.g., from L0) before progressing to Configuration to allow a change from one link width to another (e.g., an upconfigure). In one example, changing the link width (e.g., in response to detecting a traffic threshold) may involve initiating upconfiguration or downconfiguration of the link width (e.g., as implemented by the I/O controller 205 or device 310), among other example implementations.

In implementations of a link supporting multiple defined data rates (e.g., 2.5 GT/s, 5.0 GT/s, 8.0GT/s, 16.0 GT/s, 32.0 GT/s, 64.0 GT/s, etc.), link training and configuration may involve configuring and equalization at each of the data rates mutually supported by the link partners up to the highest mutually supported data rate. Equalization parameters or results from the progressive equalizations at each of the supported data rates may be saved or stored for use in later transitioning from a higher data rate to a lower data rate (and then returning to the higher data rate from the lower data rate), among other instances. In some examples, a highest mutually supported data rate may be negotiated between the link partners (e.g., during training) and the equalization procedure may skip to this highest mutually supported speed or bypass one or more lower or intermediate speeds. In some implementations, the data rates that correspond to one or more potential power savings modes may be preidentified by the system and the initial equalization may involve equalization (and storing corresponding equalization parameters for potential future use in minimizing data rate change latencies) for this subset of data rates, while bypassing equalization at other supported speeds (e.g., speeds other than the highest mutually supported speed and speeds designated as potential power saving data rates), among other examples. In some implementations, a Recovery state (e.g., 510) may be entered and training sequences exchanged to negotiate and implement a transition from one of the defined data rates to another (e.g., in association with a power management threshold detected by an I/O controller, such as discussed herein), among other example implementations.

Tables 1 and 2 below show an example of the incremental power savings that may be realized in an example NIC through transitioning between different supported link widths and different supported data rates (e.g., defined in a PCIe specification). In this particular example, approximately 4 Watts may be saved by transitioning from 16 lanes to 1 lane of a 16 GT/s link. Approximately 2 Watts can be saved by moving from a x16 link width to a x8 link width, while still maintaining significant bus bandwidth. Multiplying this across all the devices in a data center that are not running at full capacity would result in a significant savings in power. Further, power savings realized at one component (e.g., a NIC) of a system can be multiplied. For instance, if a device is consuming less power it generates less heat, which means fans and cooling systems also run less, thereby further reducing power consumption. As another example, power to a NIC or other I/O controller may be provided via a host system power supply, which may already operate with some efficiency loss. In such instances, a watt saved by a NIC card (such as using the features and functionality discussed in this disclosure) may result in greater than a watt in overall host system power savings, among other examples. Indeed, each system watt saved is a watt that can potentially be used elsewhere in the system to resolve bottlenecks (e.g., via Frequency Class of Service (CLOS)) while maintaining the system power and thermal envelope. In addition to these first order effects, there are second and third order cooling (and power savings) impacts that may be realized in system (e.g., datacenters) as well, among other examples.

TABLE 1
Power consumption of an example device
at each link width and lane speed

| | Link Speed | | Link Width | NIC Power Consumption | |
|---|---|---|---|---|---|
| Gen 4 | 16 | GT/s | x16 | 11.58 | W |
| | | | x8 | 9.51 | W |
| | | | x4 | 8.42 | W |
| | | | x1 | 7.49 | W |
| Gen 3 | 8 | GT/s | x16 | 10.06 | W |
| | | | x8 | 8.65 | W |
| | | | x4 | 7.88 | W |
| | | | x1 | 7.22 | W |
| Gen 2 | 5 | GT/s | x16 | 9.58 | W |
| | | | x8 | 8.38 | W |
| | | | x4 | 7.76 | W |
| | | | x1 | 7.18 | W |
| Gen 1 | 2.5 | GT/s | x16 | 9.03 | W |
| | | | x8 | 8.08 | W |
| | | | x4 | 7.62 | W |
| | | | x1 | 7.12 | W |

TABLE 2
Power consumption of the example of Table 1 sorted by link width

| | | | | | % Power Savings |
|---|---|---|---|---|---|
| Link Width | Link Speed | | NIC Power Consumption | | vs. Maximum |
| x16 | 16 | GT/s | 11.58 | W | 0% |
| | 8 | GT/s | 10.06 | W | 13% |
| | 5 | GT/s | 9.58 | W | 17% |
| | 2.5 | GT/s | 9.03 | W | 22% |
| x8 | 16 | GT/s | 9.51 | W | 18% |
| | 8 | GT/s | 8.65 | W | 25% |
| | 5 | GT/s | 8.38 | W | 28% |
| | 2.5 | GT/s | 8.08 | W | 30% |
| x4 | 16 | GT/s | 8.42 | W | 27% |
| | 8 | GT/s | 7.88 | W | 32% |
| | 5 | GT/s | 7.76 | W | 33% |
| | 2.5 | GT/s | 7.62 | W | 34% |
| x1 | 16 | GT/s | 7.49 | W | 35% |
| | 8 | GT/s | 7.22 | W | 38% |
| | 5 | GT/s | 7.18 | W | 38% |
| | 2.5 | GT/s | 7.12 | W | 39% |

In some implementations, the speed and/or link width changes may be accomplished by using the configuration space registers of the downstream port. Alternatively, speed and/or link width changes may be performed autonomously done from the endpoint (e.g., by I/O controller), among other example implementations.

While link width and/or speed changes may be utilized and triggered to realize power savings while the PCIe link is active, such changes do not come for free. For instance, latency is introduced to perform and complete such transitions (e.g., transitioning between supported PCIe data rates, activating/deactivating lanes, etc.). By way of illustration, Tables 3 and 4 show example exit latencies for such transitions in an example system (e.g., a PCIe 4.0 device). For instance, Table 3 shows example latencies for changing PCIe bus bandwidth (link width). In some cases, reducing lanes may be completed relatively quickly (e.g., around 8 microseconds), whereas increasing the number of lanes (e.g., upconfiguring) may be comparatively more involved (e.g., taking ˜180 microseconds). Table 4 shows example latencies for transitioning between lane speeds (e.g., with the worst performing transition being increasing the data rate to a maximum rate (e.g., taking up to ˜650 microseconds), among other example systems and corresponding latencies characteristics).

TABLE 3
Transition times changing Lane Width (using Lane Speed 16 GT/s)

| | | | | |
|---|---|---|---|---|
| Lane Width | x1 | x4 | x8 | x16 |

| x1 | 0 | | 178.02 | us | 181.1 | us | 179.43 us |
|---|---|---|---|---|---|---|---|
| x4 | ~8.35 | us | 0 | | 178.04 | us | 176.36 us |
| x8 | 8.35 | us | ~8.35 | us | 0 | | 174.89 us |
| x16 | 8.36 | us | 8.36 | us | 8.38 | us | 0 |

TABLE 4
Transition times changing Lane Speed (using x16 Lane Width)

| | | | | |
|---|---|---|---|---|
| (GT/s) | 16 | 8 | 5 | 2.5 |

| 16 | 0 | 242.58 | μs | ~231 | μs | 297.35 μs |
|---|---|---|---|---|---|---|
| 8 | ~657 μs | 0 | | 223.78 | μs | 285.94 μs |
| 5 | ~648 μs | 227.07 | μs | 0 | | 229.86 μs |
| 2.5 | ~645 μs | 223.814 | μs | 284.12 | μs | 0 |

As network speeds increase a given latency represents more “packet times.” Accordingly, in such instances, an I/O controller may additionally consider the current link speed (e.g., in addition to thresholds, or base the set of thresholds on current detected link speed), such that a power savings technique is selected that matches or is most appropriate to the current link speed. For example, with highspeed links (e.g., 100 Gb+) may be too costly to allow lane speed transitions, and only link width changes utilized to reduce power at such speeds.

In some implementations, latency introduced through power savings transitions may also negatively impact the handling of network traffic at the I/O controller (e.g., buffers struggle to handle network traffic sent/received and held as the I/O controller transitions link width and/or speed on a corresponding PCIe bus). Accordingly, the I/O controller may additionally include logic to quiesce traffic on the network link while the transitions are performed (and corresponding to a predicted or actual latency introduced through transition(s)). As one example, Exit Latency mitigation techniques may include implementing priority flow control or utilizing Pause frames among other example techniques to temporarily quiesces the network, allowing the PCIe transition.

As an illustrative example, a 100 Gb Ethernet controller (e.g., a NIC) may detect that a particular network traffic threshold has been met and trigger a corresponding power management transition of its PCIe port by changing the link width and/or data rate of the port. Further, the Ethernet controller may initiate corresponding latency mitigation to account for the latency introduced through the power management transition. For instance, a pause frame (priority or traditional) may be generated, which includes a pause value that is measured in pause quanta. For instance, each pause quanta is 512 bit-times at the current link speed. For 100 Gbit, 512 bit-times is 5.12 ns. The pause value is a two-byte unsigned integer and can range from 0 through 65535 pause quanta. So, for 100 Gbit Ethernet, the maximum pause time request is 335.5 μs, which provides the requisite time to perform at least some of the power management transitions available to the controller (e.g., more than enough time to increase the number of lanes (˜180 μs)). In some instances, latency mitigation operations available to the controller may be limited (e.g., by pause quanta limits), making it prohibitive to utilize some potential power management transitions (e.g., transition to a 16GT/s lane speed (˜650 μs)) due to the lack of sufficient, corresponding latency mitigation features. In such example, the I/O controller may be configured to not allow (or tie thresholds) such power management techniques. As an example, for 100 Gbit Ethernet, an example controller may be configured to only utilize link width changes (although other interconnects and standards (e.g., future PCIe physical layers or standards) may utilize faster clock synchronizations that would allow 100 Gbit to utilize clocking changes, among other example scenarios.

In another illustrative example, for instance, for a 40 Gbit Ethernet controller, at 40 Gbit, 512 bit-times (pause quanta) is 12.8 ns, realizing a max pause time of 838.8 μs. In this example, the maximum pause time for the controller may allow for both lane additions (e.g., ˜180 μs) and lane speed (or “data rate”) changes (e.g., ˜650 μs) to be utilized. In some instances, even when lane speed changes can be utilized, the controller may be configured to nonetheless minimize exit latency and only utilize lane additions. Indeed, DAPLS thresholds and the specific power management transitions corresponding to the thresholds may be fully configurable (e.g., through entries in a configuration register) and may be tuned to the goals for the system (e.g., maximizing performance or maximize power savings), among other examples.

While some of the examples herein specify the use of pause frames for use in mitigating exit latency, other techniques may also be used. As an example, some I/O controllers (e.g., server class NICs) may be provided with multiple PCIe ports connections to the server to implement a multi-host or PCIe multi-homed device. Multi-host allows for redundancy and/or for packets to be routed to particular NUMA nodes. In such systems, the multiple PCIe ports may be leveraged to assist in latency mitigation. For instance, while PCIe lane and/or data rate changes are triggered on one of the multiple PCIe ports, the controller may cause concurrent PCIe traffic intended for this port to be temporarily rerouted to the other PCIe port(s) until the transition is complete (e.g., allowing pause frames or similar latency mitigation techniques to be omitted). By way of illustration, an example multi-host NIC may be configured to have up to four x4 PCIe links each running at their own frequency. DAPLS functionality provided on the NIC could apply power management transitions (e.g., independently) at each one of the available PCIe link ports depending on the number of packets going to the NUMA node to which it is attached. When a particular one of the multiple PCIe link is transitioning based on a detected amount of traffic, its packets may be temporarily sent to another NUMA node and then traverse a processor interconnect (e.g., UPI) based on the memory address while the particular PCIe transition. In some implementations, to simplify such temporary “link sharing” for latency mitigation purposes, a controller may enforce a policy to limit the number of the PCIe links which may implement a DAPLS transition at any one time (e.g., ensure that no more than one of the PCIe links is transitioning at a time), among other example policies, features, and implementations.

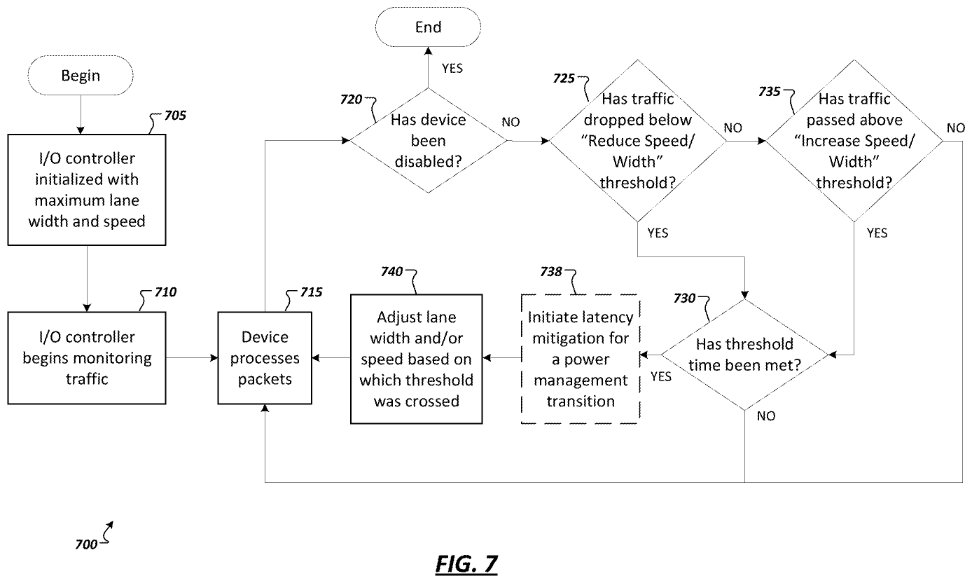

Turning to FIG. 7, a flow diagram 700 is shown illustrating an example technique for managing power at an example I/O controller. A link (e.g., a PCIe link) coupling the I/O controller to another device (e.g., a host device) may be initialized 705 with maximum lane width and speed to attempt to maximize throughput over the link. Network traffic (received or sent on a port (e.g., an Ethernet port) of the I/O controller may be monitored 710. The traffic may be monitored directly at the port (e.g., packet counting) or by monitoring capacity of buffers used to buffer data to be received or sent on the network using the I/O controller, among other examples. The device coupled to the I/O controller may process packets 715 received or to be sent on the network. As the traffic is monitored (e.g., 710) the I/O controller may determine whether the traffic has dropped below (at 725) a threshold for which a reduction in data rate (speed) and/or link width is associated to conserve power. Similarly, the I/O controller may determine whether the traffic has passed above (at 735) a threshold for which an increase in speed and/or link width is to be triggered (e.g., to accommodate accelerating network traffic). When either threshold is met (e.g., at 725 or 735), the I/O controller may additionally determine (at 730) whether this threshold is met (e.g., at, below, or above the threshold depending on the defined threshold) for a defined threshold amount of time. If the threshold is met for the defined period of time, a power management transition may be initiated by causing the link (e.g., using state machine or protocol logic of the I/O controller interface implementing the link (e.g., a PCIe interface or port)) to adjust the link width (or lane width) of the link and/or the data rate used on the link (at 740). Operation of the I/O controller may continue at the adjusted link characteristics, with network traffic continuing to be monitored (at 710) to determine whether other thresholds are met to cause an additional power management transition at the link. This process may continue until the device (or the I/O controller) is disabled and packets are no longer processed, among other example features and embodiments. For instance, latency mitigation (e.g., at 738) may also be employed in associated with power management transitions to avoid the build of network data to be sent or received (e.g., and corresponding buffer overflow) while the link is transition from one link width and/or data rate to another.

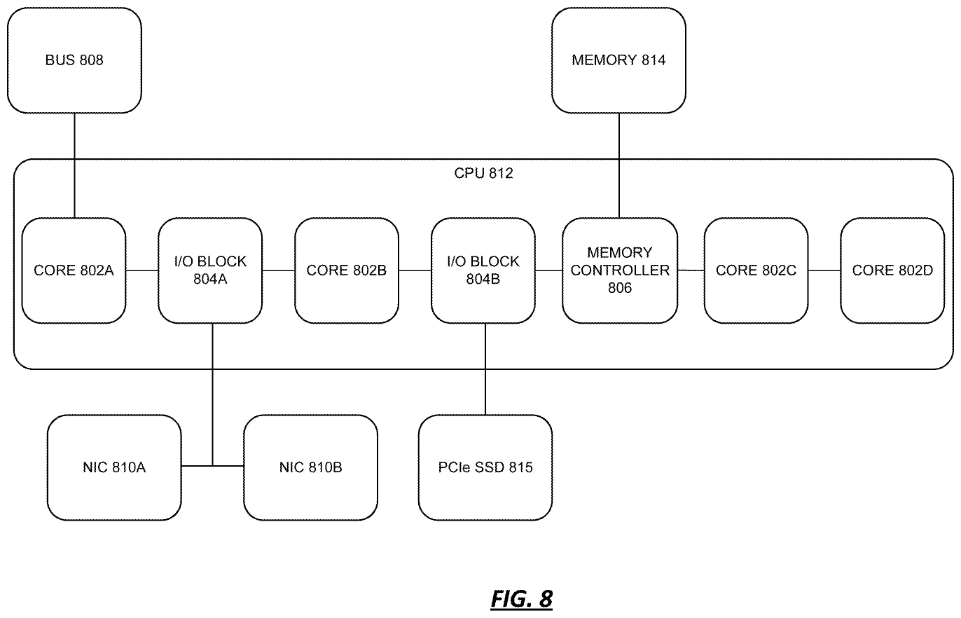

FIG. 8 illustrates a block diagram of an example data processor device (e.g., a central processing unit (CPU)) 812 coupled to various other components of a platform in accordance with certain embodiments. Although CPU 812 depicts a particular configuration, the cores and other components of CPU 812 may be arranged in any suitable manner. CPU 812 may comprise any processor or processing device, such as a microprocessor, an embedded processor, a digital signal processor (DSP), a network processor, an application processor, a co-processor, a system on a chip (SOC), or other device to execute code. CPU 812, in the depicted embodiment, includes four processing elements (cores 802 in the depicted embodiment), which may include asymmetric processing elements or symmetric processing elements. However, CPU 812 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 812, as illustrated in FIG. 8, includes four cores—cores 802A, 802B, 802C, and 802D, though a CPU may include any suitable number of cores. Here, cores 802 may be considered symmetric cores. In another embodiment, cores may include one or more out-of-order processor cores or one or more in-order processor cores. However, cores 802 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 802 may include a decode module coupled to a fetch unit to decode fetched elements. Fetch logic, in one embodiment, includes individual sequencers associated with thread slots of cores 802. Usually a core 802 is associated with a first ISA, which defines/specifies instructions executable on core 802. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 802 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 802, in one embodiment, recognize the same ISA (or a subset thereof). Alternatively, in a heterogeneous core environment, a decoder of one or more cores (e.g., core 802B) may recognize a second ISA (either a subset of the first ISA or a distinct ISA).

In various embodiments, cores 802 may also include one or more arithmetic logic units (ALUs), floating point units (FPUs), caches, instruction pipelines, interrupt handling hardware, registers, or other suitable hardware to facilitate the operations of the cores 802.

Bus 808 may represent any suitable interconnect coupled to CPU 812. In one example, bus 808 may couple CPU 812 to another CPU of platform logic (e.g., via UPI). I/O blocks 804 represents interfacing logic to couple I/O devices 810 and 815 to cores of CPU 812. In various embodiments, an I/O block 804 may include an I/O controller that is integrated onto the same package as cores 802 or may simply include interfacing logic to couple to an I/O controller that is located off-chip. As one example, I/O blocks 804 may include PCIe interfacing logic. Similarly, memory controller 806 represents interfacing logic to couple memory 814 to cores of CPU 812. In various embodiments, memory controller 806 is integrated onto the same package as cores 802. In alternative embodiments, a memory controller could be located off chip.

As various examples, in the embodiment depicted, core 802A may have a relatively high bandwidth and lower latency to devices coupled to bus 808 (e.g., other CPUs 812) and to NICs 810, but a relatively low bandwidth and higher latency to memory 814 or core 802D. Core 802B may have relatively high bandwidths and low latency to both NICs 810 and PCIe solid state drive (SSD) 815 and moderate bandwidths and latencies to devices coupled to bus 808 and core 802D. Core 802C would have relatively high bandwidths and low latencies to memory 814 and core 802D. Finally, core 802D would have a relatively high bandwidth and low latency to core 802C, but relatively low bandwidths and high latencies to NICs 810, core 802A, and devices coupled to bus 808.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: an I/O controller including: a port to couple to a network; a buffer to buffer network data; an interface to support a link to couple the I/O controller to another device; and a power manager. The power manager is to: monitor the buffer to determine an amount of traffic on the port; determine that the amount of traffic meets a threshold; and initiate, at the interface, a power management transition on the link based on the determination that the amount of traffic meets the threshold.

Example 2 includes the subject matter of example 1, where the power management transition includes changing a link width of the link by activating or deactivating a subset of lanes associated with the link based on the threshold.

Example 3 includes the subject matter of example 2, where the power management transition further includes changing a data rate of the link.

Example 4 includes the subject matter of any one of examples 2-3, where changing a link width of the link includes a transition of the link from an active link state to a configuration state, communication of training sequences in the configuration state to negotiate the transition of the link from a first link width to a different, second link width.

Example 5 includes the subject matter of any one of examples 2-3, where changing a link width of the link includes a transition of the link from an active link state to a partial width link state, and the partial width link state is defined in a Peripheral Component Interconnect Express (PCIe)-based state machine.

Example 6 includes the subject matter of any one of examples 1-5, where the power management transition includes changing a data rate of the link from a first speed to a second speed based on the threshold.

Example 7 includes the subject matter of any one of examples 1-6, where the threshold includes a particular one of a plurality of thresholds, and a respective one of a plurality of different power management transitions is to be performed in association with each one of the plurality of thresholds.

Example 8 includes the subject matter of any one of examples 1-7, where the power manager is further to: determine a latency associated with the power management transition; and initiate a mitigation of the latency at the port.

Example 9 includes the subject matter of example 8, where the mitigation includes sending pause frames on the port to quiesce traffic on the port.

Example 10 includes the subject matter of example 8, where the port includes a first one of a plurality of ports of the I/O controller to couple to the network, where the mitigation includes rerouting traffic over a second one of the plurality of ports while the power management transition is performed.

Example 11 includes the subject matter of any one of examples 8-10, where the power management transition is a particular one of a plurality of power management transitions associated with a plurality of thresholds, a respective latency is associated with each of the plurality of power management transitions, and the mitigation is selected from a plurality of available mitigations based on the respective latency associated with the particular power management transition.

Example 12 includes the subject matter of any one of examples 1-11, where the link is based on a PCIe protocol, and the power management transition is to be performed based on the PCIe protocol.

Example 13 includes the subject matter of example 12, where the port includes an Ethernet port.

Example 14 includes the subject matter of any one of examples 1-13, where the I/O controller includes a network interface controller (NIC).

Example 15 includes the subject matter of any one of examples 1-14, where the amount of traffic is determined to meet the threshold based on the amount of traffic being above or below the threshold for a threshold amount of time.

Example 16 includes the subject matter of any one of examples 1-15, where the threshold includes a configurable value to be set by a user.

Example 17 includes the subject matter of example 16, where the power management transition is a user-defined action associated with the threshold.

Example 18 is a method including: monitoring buffers of a network adapter device to determine an amount of network traffic at the network adapter; determining that the amount of network traffic meets a threshold; and initiating, at a Peripheral Component Interconnect Express (PCIe) interface of the network adapter, a change to a link coupling the network adapter to another device in a computing system, where the change is to adjust power usage at the link based on the threshold, and the change includes at least one of a change to a data rate of the link or a change to a link width of the link.

Example 19 includes the subject matter of example 18, where determining that the amount of network traffic meets the threshold includes determining that the amount of network traffic exceeds or falls below a threshold amount defined by the threshold for a period of time.

Example 20 includes the subject matter of any one of examples 18-19, where the power management transition includes changing a link width of the link by activating or deactivating a subset of lanes associated with the link based on the threshold.

Example 21 includes the subject matter of example 20, where changing a link width of the link includes a transition of the link from an active link state to a configuration state, communication of training sequences in the configuration state to negotiate the transition of the link from a first link width to a different, second link width.

Example 22 includes the subject matter of example 20, where changing a link width of the link includes a transition of the link from an active link state to a partial width link state, and the partial width link state is defined in a Peripheral Component Interconnect Express (PCIe)-based state machine.

Example 23 includes the subject matter of any one of examples 18-22, where the power management transition includes changing both the data rate of the link or the link width of the link based on the threshold.

Example 24 includes the subject matter of any one of examples 18-23, where the threshold includes a particular one of a plurality of thresholds, and a respective one of a plurality of different power management transitions is to be performed in association with each one of the plurality of thresholds.

Example 25 includes the subject matter of any one of examples 18-24, further including: determining a latency associated with the power management transition; and initiating a mitigation of the latency at the port.

Example 26 includes the subject matter of example 25, where the mitigation includes sending pause frames on the port to quiesce traffic on the port.

Example 27 includes the subject matter of example 25, where the port includes a first one of a plurality of ports of the I/O controller to couple to the network, where the mitigation includes rerouting traffic over a second one of the plurality of ports while the power management transition is performed.

Example 28 includes the subject matter of any one of examples 25-27, where the power management transition is a particular one of a plurality of power management transitions associated with a plurality of thresholds, a respective latency is associated with each of the plurality of power management transitions, and the mitigation is selected from a plurality of available mitigations based on the respective latency associated with the particular power management transition.

Example 29 includes the subject matter of any one of examples 18-28, where the power management transition is to be performed based on the PCIe protocol.

Example 30 includes the subject matter of example 29, where the network traffic is sent and receiver over an Ethernet port.

Example 31 includes the subject matter of any one of examples 18-30, where the network adapter includes a network interface controller (NIC).

Example 32 includes the subject matter of any one of examples 18-31, where the threshold includes a configurable value to be set by a user.

Example 33 includes the subject matter of example 32, where the power management transition is a user-defined action associated with the threshold.

Example 34 is a system including means to perform the method of any one of examples 18-33.

Example 35 includes the subject matter of examples 34, where the means includes a non-transitory computer-readable storage medium with instructions stored thereon, the instruction executable by a machine to cause the machine to perform at least a portion of the method of any one of examples 18-33.

Example 36 is a system including: a first device; and an I/O controller device coupled to the first device by a link compliant with a PCIe-based interconnect protocol, where the I/O controller device includes: a port to couple to a network; a buffer to buffer network data; an interface to support the link, where the link is to be used to send data from the network to the first device and receive data from the first to send on the network; and a power manager. The power manager is to: monitor the buffer to determine an amount of traffic on the port; determine that the amount of traffic meets a threshold; and initiate, at the interface, a power management transition on the link based on the determination that the amount of traffic meets the threshold.

Example 37 includes the subject matter of example 36, where the I/O device includes a network interface controller (NIC).

Example 38 includes the subject matter of any one of examples 36-37, where the first device includes a host processor.

Example 39 includes the subject matter of any one of examples 36-38, where the power management transition includes changing a link width of the link by activating or deactivating a subset of lanes associated with the link based on the threshold.

Example 40 includes the subject matter of example 39, where the power management transition further includes changing a data rate of the link.

Example 41 includes the subject matter of any one of examples 39-40, where changing a link width of the link includes a transition of the link from an active link state to a configuration state, communication of training sequences in the configuration state to negotiate the transition of the link from a first link width to a different, second link width.

Example 42 includes the subject matter of example 39, where changing a link width of the link includes a transition of the link from an active link state to a partial width link state, and the partial width link state is defined in a Peripheral Component Interconnect Express (PCIe)-based state machine.

Example 43 includes the subject matter of any one of examples 36-42, where the power management transition includes changing a data rate of the link from a first speed to a second speed based on the threshold.

Example 44 includes the subject matter of any one of examples 36-43, where the threshold includes a particular one of a plurality of thresholds, and a respective one of a plurality of different power management transitions is to be performed in association with each one of the plurality of thresholds.

Example 45 includes the subject matter of any one of examples 36-44, where the power manager is further to: determine a latency associated with the power management transition; and initiate a mitigation of the latency at the port.

Example 46 includes the subject matter of example 45, where the mitigation includes sending pause frames on the port to quiesce traffic on the port.

Example 47 includes the subject matter of example 45, where the port includes a first one of a plurality of ports of the I/O controller to couple to the network, where the mitigation includes rerouting traffic over a second one of the plurality of ports while the power management transition is performed.

Example 48 includes the subject matter of any one of examples 45-47, where the power management transition is a particular one of a plurality of power management transitions associated with a plurality of thresholds, a respective latency is associated with each of the plurality of power management transitions, and the mitigation is selected from a plurality of available mitigations based on the respective latency associated with the particular power management transition.

Example 49 includes the subject matter of any one of examples 36-48, where the power management transition is to be performed based on the PCIe protocol.

Example 50 includes the subject matter of example 49, where the port includes an Ethernet port.

Example 51 includes the subject matter of any one of examples 36-50, where the amount of traffic is determined to meet the threshold based on the amount of traffic being above or below the threshold for a threshold amount of time.

Example 52 includes the subject matter of any one of examples 36-51, where the threshold includes a configurable value to be set by a user.

Example 53 includes the subject matter of example 52, where the power management transition is a user-defined action associated with the threshold.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
an I/O controller comprising:
a port to couple to a network;
an interface to support a link to couple the I/O controller to another device; and
a power manager to:
monitor a buffer to determine an amount of traffic on the port;
initiate, at the interface, a power management transition on the link based on the amount of traffic; and
mitigate latency associated with the power management transition at the port.

2. The apparatus of claim 1, wherein the power management transition comprises changing a link width of the link by activating or deactivating a subset of lanes associated with the link based on the threshold.

3. The apparatus of claim 2, wherein the power management transition comprises both changing the link width and changing a data rate of the link.

4. The apparatus of claim 2, wherein changing a link width of the link comprises a transition of the link from an active link state to a configuration state, communication of training sequences in the configuration state to negotiate the transition of the link from a first link width to a different, second link width.

5. The apparatus of claim 2, wherein changing a link width of the link comprises a transition of the link from an active link state to a partial width link state, and the partial width link state is defined in a Peripheral Component Interconnect Express (PCIe)-based state machine.

6. The apparatus of claim 1, wherein the power management transition comprises changing a data rate of the link from a first speed to a second speed based on the threshold.

7. The apparatus of claim 1, wherein the power manager is further to determine that the amount of traffic meets a threshold, and the power management transition on the link is based on the determination that the amount of traffic meets the threshold.

8. The apparatus of claim 7, wherein the threshold comprises a particular one of a plurality of thresholds, and a respective one of a plurality of different power management transitions is to be performed in association with each one of the plurality of thresholds.

9. The apparatus of claim 1, wherein the mitigation comprises sending pause frames on the port to quiesce traffic on the port.

10. The apparatus of claim 1, wherein the port comprises a first one of a plurality of ports of the I/O controller to couple to the network, wherein the mitigation comprises rerouting traffic over a second one of the plurality of ports while the power management transition is performed.

11. The apparatus of claim 1, wherein the power management transition is a particular one of a plurality of power management transitions associated with a plurality of thresholds, a respective latency is associated with each of the plurality of power management transitions, and the mitigation is selected from a plurality of available mitigations based on the respective latency associated with the particular power management transition.

12. The apparatus of claim 1, wherein the link is based on a PCIe protocol, and the power management transition is to be performed based on the PCIe protocol.

13. The apparatus of claim 12, wherein the port comprises an Ethernet port.

14. The apparatus of claim 1, wherein the I/O controller comprises a network interface controller (NIC).

15. The apparatus of claim 1, wherein the amount of traffic is determined to meet the threshold based on the amount of traffic being above or below the threshold for a threshold amount of time.

16. A method comprising:
monitoring buffers of a network adapter device to determine an amount of network traffic at the network adapter;
determining that the amount of network traffic meets a threshold; and
initiating, at a Peripheral Component Interconnect Express (PCIe) interface of the network adapter, a change to a link coupling the network adapter to another device in a computing system, wherein the change is to adjust power usage at the link based on the threshold, and the change comprises at least one of a change to a data rate of the link or a change to a link width of the link.

17. The method of claim 16, wherein determining that the amount of network traffic meets the threshold comprises determining that the amount of network traffic exceeds or falls below a threshold amount defined by the threshold for a period of time.

18. A system comprising:
a first device; and
an I/O controller device coupled to the first device by a link compliant with a PCIe-based interconnect protocol, wherein the I/O controller device comprises:
a port to couple to a traffic source;
a buffer to buffer data from the traffic source;
an interface to support the link, wherein the link is to be used to send data from the traffic source to the first device and receive data from the first to send on the traffic source; and
a power manager to:
monitor the buffer to determine an amount of traffic on the port;
initiate, at the interface, a power management transition on the link based on the determined amount of traffic; and
mitigate latency associated with the power management transition at the port.

19. The system of claim 18, wherein the I/O device comprises a network interface controller (NIC).

20. The system of claim 19, wherein the first device comprises a host processor.
